(19) United States
(12) Patent Application Publication
(10) Pub. No.: US 2025/0320942 A1
(43) Pub. Date: Oct. 16, 2025

(54) CONNECTION ASSEMBLY HAVING AN INSTALLATION CONNECTION DEVICE AND A FIT-ON CONNECTION DEVICE

(71) Applicant: NEXANS, Courbevoie (FR)

(72) Inventors: Franz VÖLKL, FLOSSENBÜRG (DE); Alexander STEINERT, FLOSTRASSE (DE); Richard RIEDEL, FLOSTRASSE (DE)

(21) Appl. No.: 19/039,134

(22) Filed: Jan. 28, 2025

(30) Foreign Application Priority Data
Jan. 31, 2024 (DE) 102024102767.3

(51) Int. Cl. F16L 47/00; H01R 13/52; H01R 43/00

(52) U.S. Cl. CPC F16L 47/00; H01R 43/005; H01R 13/5202

(57) ABSTRACT

An installation connection device for installation in a housing opening includes a body, which has an installation portion, and a connection portion. The installation portion has a sealing means designed for sealing with respect to the housing opening or with respect to the housing wall containing the housing opening and is delimited at the transition to the connection portion by a stop structure. The installation portion also has fixing structures designed to fix the installation portion in the housing opening or to the wall surrounding the housing opening. On the side of the stop structure opposite from the installation portion, a collar having a peripherally closed wall is integrally formed on the stop structure. In the body, a holder is removably supported and fixed without a seal, which holder is designed to releasably receive, without a seal, one or more first line connection devices, which each provide a connection point of a line connected thereto for a corresponding second line connection device provided in a fit-on connection device coupled to the connection portion. The holder is supported in the body such that the first line connection devices are accessible within the space surrounded by the collar wall.

This application claims the benefit of priority to German Patent Application No. 10 2024 102767.3, filed on Jan. 31, 2024, the entirety of which is incorporated by reference.

### FIELD

The present invention relates to a connection assembly for installation in a housing opening, comprising an installation connection device and a complementary fit-on connection device.

### BACKGROUND

In many areas of technology, connection assemblies for electrical or fluid connections are used by means of which one or more lines are led out of or into a housing.

Closed housings sealed against the ingress of solids or fluids generally require connection assemblies which do not compromise the seal-tightness of the housing. For this purpose, the lines are typically individually sealed against an installation connection device inserted into a housing opening, and the installation connection device is sealed against the housing.

Parts of an exemplary connection assembly 10 of known design are shown in FIG. 1. In the example, four electrical lines 12 are led out of a corrugated tube 14. Each of the lines 12 is provided with a seal 16. The lines are fixed in position relative to a plugging connector 20 by means of a sleeve 18. An enlarged view of the seals arranged around the individual lines is shown in FIG. 2.

FIG. 3 shows the exemplary connection assembly 10 in the completed state. The lines 12 are guided in a connection housing 22, which has, on the outside thereof in a portion to be placed in a housing opening (not shown in the figure), a peripheral seal 24. The seals 16 of the lines interact, in the interior of the connection housing 22, with lead-throughs for the lines and thus bring about the complete seal-tightness of a housing with the connection assembly 10 inserted into the housing opening. When mounting the known connection assembly 10, first the plugging connector 20 is to be led through the housing opening and connected in the interior of the housing, and thereafter the connection housing 22 is to be inserted into the housing opening. It is easy to recognize that, depending on the position of the connections in the interior of the housing, an additional access point may be necessary.

Alternatively, it is also possible to use connection assemblies for electrical or fluid connections in the case of which one or more lines are led out of a housing and are provided at an installation connection device for contacting, the installation connection device being connected to the housing and sealing the housing. The installation connection device can provide a plug or a socket, which establish the desired connection with a complementary socket or a plug, respectively. Plugs and sockets are often also called male and female connection devices, respectively. An example of such an alternative connection assembly are the plugging connectors according to the MIL-C standard. Here, one or more lines are connected to plugging contacts or plugging sleeves and fixed in a housing. A rubber seal having holes for each plugging contact or each plugging sleeve is disposed on the open side in the housing. When a corresponding mating part is connected, the rubber seal is compressed and seals each plugging contact or each plugging sleeve. The sealing of each individual plugging contact or of each plugging sleeve imposes very high requirements on the dimensional accuracy of the components and the accuracy of fit of the mating part, and also on the force with which the mating part is attached. In addition, a large number of possible leaky points result, which makes troubleshooting difficult.

Therefore, it is an object of the invention to propose a connection assembly comprising an installation connection device and a fit-on connection device, that reduces the number of individual sealing points.

### DESCRIPTION OF THE INVENTION

This object is achieved by the installation connection device specified in claim 1, said installation connection device and the fit-on connection device specified in claim 5 representing the essential parts of the connection assembly specified in claim 7. Advantageous embodiments and developments are specified in the respective dependent claims.

According to a first aspect of the invention, an installation connection device for installation in a housing opening comprises a body, which has an installation portion of round cross section, and a connection portion. The installation portion comprises a radially peripheral sealing means designed for sealing with respect to the housing opening or with respect to the housing wall containing the housing opening. At the transition to the connection portion, the installation portion is delimited by a stop structure. The installation portion also has one or more fixing structures designed to fix the installation portion in the housing opening or to the wall surrounding the housing opening. The fixing structures can be flexible themselves, for example made of plastic or metal, or can be flexibly supported. In the latter case, the fixing structures themselves can be rigid. The fixing structures can comprise, for example, locking hooks or the like which engage in corresponding holes of the housing opening or reach behind the housing wall. The fixing structures are designed such that, in the state of installation in a suitable housing opening, they limit or prevent movement, in the installation direction, of the installation connection device installed in the housing opening.

The holes or structures of the housing opening or of the wall surrounding the housing opening can be designed such that a rotation of the inserted body by a minimum angle, optionally with simultaneous application of a tensile force to the installation connection device, deflects the fixing structures toward the center of the body so that the fixing structures no longer protrude beyond the outer periphery of the installation portion and the installation connection device can be removed from the housing opening.

On the side of the stop structure opposite from the installation portion, a collar having a peripherally closed wall is integrally formed on the stop structure. In the body, a holder is removably supported and fixed without a seal, which holder is designed to releasably receive, without a seal, one or more first line connection devices. The line connection devices each provide a connection point of a line connected thereto for a corresponding second line connection device provided in a fit-on connection device according to a second aspect of the invention described below, said fit-on connection device being coupled to the connection portion. The holder is supported in the body such that the one or more first line connection devices are accessible within the space surrounded by the collar wall. In this context, “accessible” implies that the first line connection devices can be contacted by the second line connection devices when the fit-on connection device is properly coupled to the installation connection device.

As explained above, a line connection device can comprise contact pins, contact sleeves, spring contacts, fluid couplings or the like.

In one or more embodiments of the installation connection device, one or more first guide structures for positioning and/or guiding a fit-on connection device according to the second aspect of the invention are provided on the collar wall. Alternatively or in addition, one or more first locking structures for locking a fit-on connection device according to the second aspect of the invention which is coupled to the connection portion are provided on the collar wall.

In one or more embodiments of the installation connection device, one or more positioning structures for positioning the installation connection device in a housing opening are provided on the stop structure. These positioning structures can comprise projecting or protruding structures which interact with corresponding structures of the housing and which limit or prevent a change in position of the installation connection device in the housing opening, in particular a rotation of the installation connection device about an axis running parallel to the installation direction.

While the peripheral sealing means of the installation connection device according to invention establishes the seal-tightness with respect to fluids and solids between the housing and the body, seal-tightness between the body and the holder or between the holder and the one or more line connection devices is not necessarily ensured. The complete seal-tightness of the connection assembly is not established until a fit-on connection device according to the second aspect of the invention is coupled.

A fit-on connection device according to the second aspect of the invention comprises a body, which has a fit-on portion and a connection portion. The fit-on portion has a form closed in a cup-like manner, the contour of which follows the collar of the installation connection device according to the first aspect of the invention and which is designed to surround the collar. In or on the floor of the fit-on portion, one or more second line connection devices are arranged, which correspond with corresponding first line connection devices of the installation connection device and are designed to contact said first line connection devices. In the interior of the form closed in a cup-like manner, a sealing means is arranged on the floor of the fit-on portion or near the floor along the inside of the form closed in a cup-like manner, said sealing means being designed to interact with the collar of the installation connection device in the connected state and to seal, toward the floor of the form closed in a cup-like manner, the internal space formed by the collar of the installation connection device. Lines each connected to a second line connection device are led fluid-tight through the floor of the form closed in a cup-like manner and into the connection portion and the connection portion leads the lines out of the fit-on connection device without a seal. Alternatively, lines each connected to a second line connection device are led, without a seal, through the floor of the form closed in a cup-like manner and into the connection portion, and the connection portion leads the lines out of the fit-on connection device through a sealing means, or leads the lines into a line guide element which is connected to the connection portion fluid-tight by a sealing means.

The arrangement of the seals ensures that the connection assembly, which comprises an installation connection device and a fit-on connection device properly coupled to the installation connection device, is sealed against fluids and solids so that neither fluids nor solids can enter the housing. The connection of the line to components arranged in the interior of the housing is thus simplified in comparison with previous connection assemblies.

In one or more embodiments of the fit-on connection device, one or more second guide structures designed to interact with corresponding first guide structures of the installation connection device are provided in the wall of the form closed in a cup-like manner. Alternatively or in addition, one or more second locking structures designed to interact with the one or more first locking structures of the installation connection device are provided on or in the wall of the form closed in a cup-like manner.

In one or more embodiments of the fit-on connection device, the one or more second line connection devices comprise fluid couplings or electrically conductive contact pins, contact sleeves or spring clamps.

A method for mounting an installation connection device according to the first aspect of the invention comprises providing a housing, which has a housing opening and one or more lines connected within the housing, and providing a body of the installation connection device. The one or more lines are first led through the housing opening out of the interior of the housing. If the one or more lines are not yet provided with first line connection devices, the method also comprises providing first line connection devices and connecting each of the one or more lines to a respective first line connection device. If the first line connection devices connected to lines are not yet supported and fixed in a holder, the method also comprises providing a holder, and arranging the first line connection devices connected to lines in the holder. The holder is then received in the provided body, and the installation portion of the completed installation connection device is inserted into and fixed in the housing opening.

### BRIEF DESCRIPTION OF THE DRAWING

The invention is described below, by way of example, with reference to the drawing. In the drawing:

FIG. 1 shows parts of an exemplary connection assembly of known design,

FIG. 2 shows a detail view of the parts of the connection assembly of FIG. 1,

FIG. 3 shows a completed connection assembly from FIG. 1,

FIG. 4 shows a plurality of lines for arranging in a holder before they are fixedly connected to respective line connection devices, said holder being provided for use with the installation connection device according to the invention,

FIG. 5 shows the line connection devices received in a holder, with the lines connected to said line connection devices,

FIG. 6 shows an installation connection device with a holder inserted therein, in a perspective rear view,

FIG. 7 shows the installation connection device from FIG. 6 in an oblique front view,

FIG. 8 shows a second exemplary embodiment of an installation connection device in an oblique front view,

FIG. 9 shows another view of the second exemplary embodiment of the installation connection device according to the invention in an oblique front view,

FIG. 10 shows an installation connection device according to the invention mounted in a housing,

FIG. 11 shows another example of an installation connection device mounted in a housing,

FIG. 12 shows an exemplary embodiment of a part of a fit-on connection device according to the invention fitted on an installation connection device according to the invention,

FIG. 13 shows an installation connection device according to the invention mounted in a housing, with fitted-on fit-on portion of a fit-on connection device according to the invention, and

FIG. 14 shows an exemplary flowchart of a method for mounting an installation connection device according to the invention in a housing opening.

In the figures, identical or similar elements can be referenced with the same reference signs.

### DESCRIPTION OF EXEMPLARY EMBODIMENTS

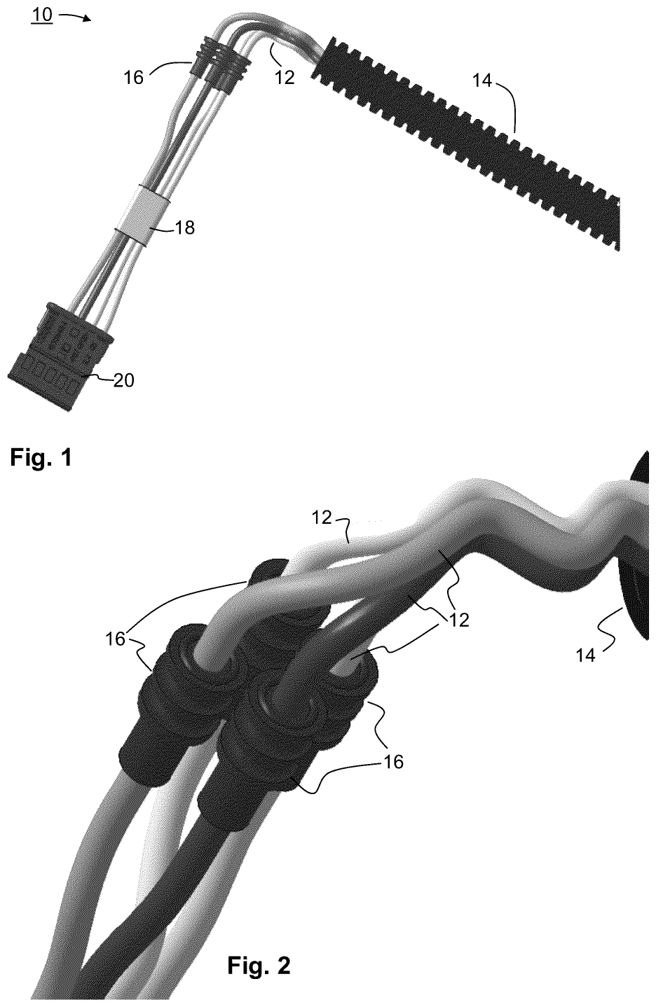

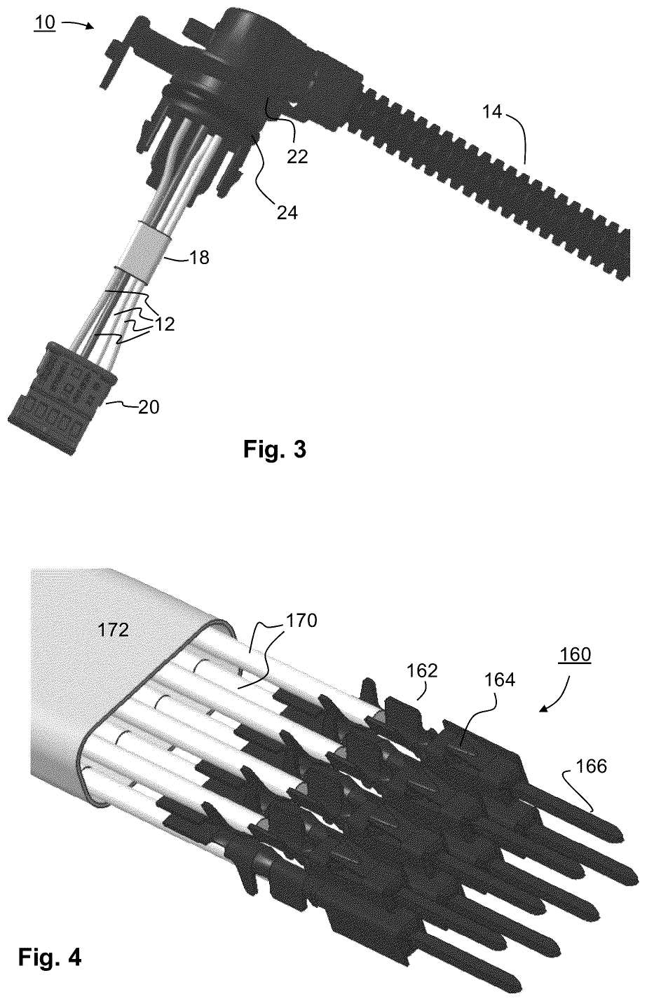

FIGS. 1 to 3 have already been described above and are therefore not explained again.

FIG. 4 shows a plurality of lines 170 for arranging in a holder 150 before they are fixedly connected to respective line connection devices 160, said holder being provided for use with the installation connection device 100 according to the invention. The lines are guided in a tube, which serves as a line guide element 172. The line connection devices 160, only some of which, for reasons of clarity, are provided with reference signs, have a crimp connection point 162 for connecting the respective line 170 and are provided with contact pins 166 for connecting to corresponding sleeves, sockets, clamping springs or the like. A locking element 164 which serves for fixing the line connection device 160 in the holder 150 is arranged between the crimp connection point 162 and the contact pin 166.

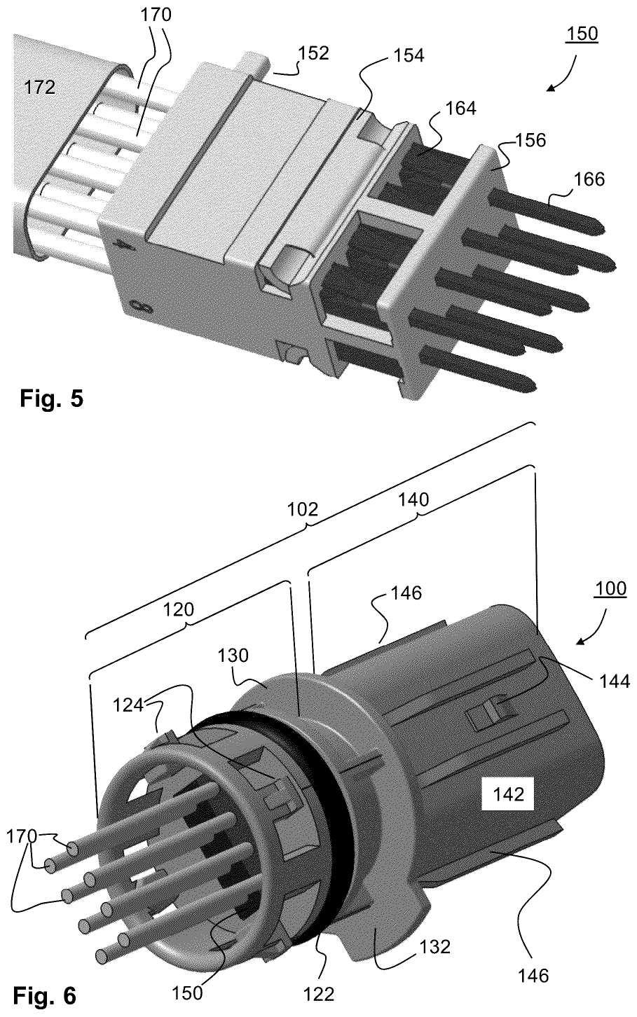

FIG. 5 shows the line connection devices 160 received in a holder 150, with the lines 170 connected to said line connection devices. The figure clearly shows how the locking elements 164 of the line connection devices 160 are supported on the holder 150 and prevent the line connection devices 160 from being removed from the holder 150. The contact pins 166 are led through a front plate 156 and fixed in position. A locking element 154 is provided on the holder 150, the upper edge of which locking element interacts with a corresponding protrusion in the body 102 of the installation connection device 100 and prevents the holder 150 from being removed from the body 102. The locking element 154 can be flexibly supported or, as shown here, can itself be flexible so that, when said locking element is pressed down, the holder 150 can be removed from the body 102. A projecting protuberance 152 is used to correctly orient the holder 150 in the body 102 of the installation connection device 100, the installation connection device having a corresponding complementary recess.

FIG. 6 shows a first exemplary embodiment of an installation connection device 100 with a holder 150 inserted therein, in a perspective rear view. The body 102 of the installation connection device 100 is divided into an installation portion 120 having a round cross section and a connection portion 140, with a stop structure 130 lying therebetween. Of the holder 150, only the rear side within the installation portion 120 can be seen, and also the lines 170 arranged therein, which, for better clarity, are not all provided with reference signs. The installation portion 120 comprises fixing means 124, which fix the one installation connection device 100 in a housing opening once said installation connection device has been installed in the housing opening. In the example shown in the figure, the fixing means 124 are flexible locking hooks. The installation portion 120 also comprises a sealing means 122, here a peripheral sealing ring. The connection portion 140 comprises a collar 142 having a peripherally closed wall. On the collar 142, a locking structure 144 can be seen—here in the form of a locking projection. First guide means 146 are also provided on the collar, said first guide means interacting with corresponding second guide structures 246 (not shown in the figure) of a fit-on connection device 200 (not shown in the figure). The stop structure 130 comprises a positioning structure 132, which, in order to position the installation connection device 100 in a housing opening, interacts with a corresponding structure at or in the housing opening.

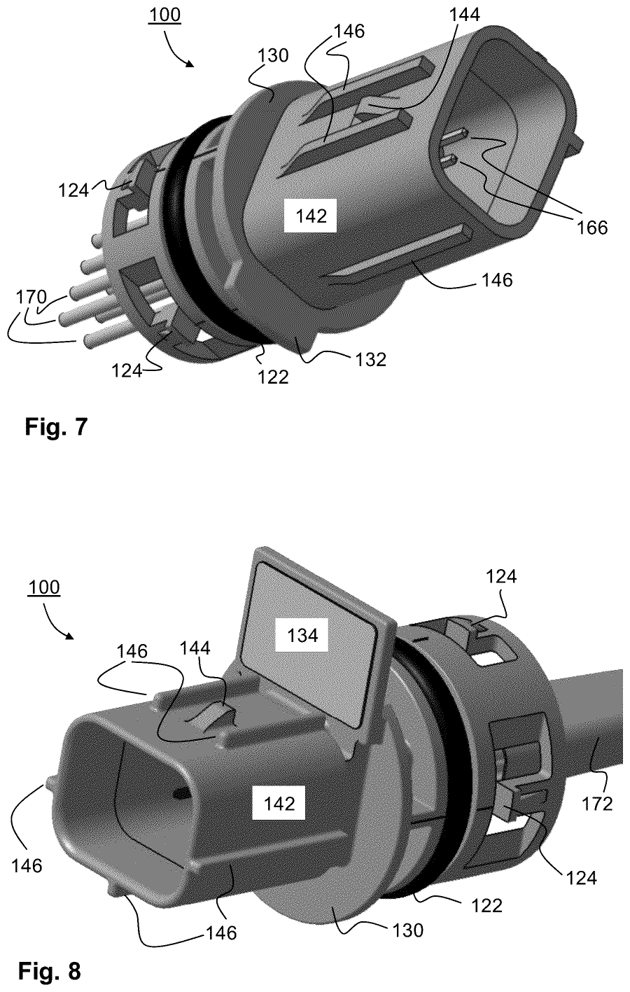

FIG. 7 shows the installation connection device 100 from FIG. 6 in an oblique front view. In this view, the peripherally closed wall of the collar 142 is clearly visible, as are the contact pins 166, which are accessible in the space surrounded by the collar 142. The locking structure 144 and the first guide structures 146 are also clearly visible.

FIG. 8 shows a second exemplary embodiment of an installation connection device 100 in an oblique front view. This exemplary embodiment corresponds essentially to the exemplary embodiment from FIGS. 6 and 7. In contrast thereto, here a protruding plate 134 running parallel to the stop structure is provided. The plate 134 can be used for marking purposes, e.g. by affixing a sticker or by printing thereon. The other elements correspond to those of the first exemplary embodiment and are not discussed again here.

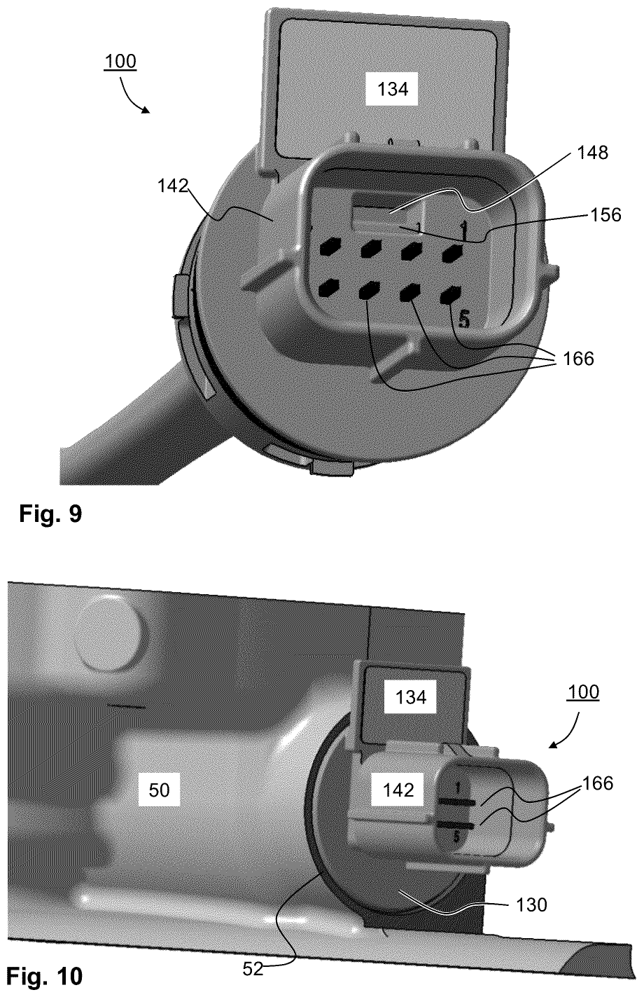

FIG. 9 shows another view of the second exemplary embodiment of the installation connection device 100 according to the invention in an oblique front view. In this view, it is clear how the contact pins 166 are accessible in the space surrounded by the collar 142. Also clear is a through-hole 148 in the floor of the space surrounded by the collar 142, through which the locking element 154 of the holder 150 can be actuated. At the bottom edge of the through-hole 148, part of the front plate 156 of the holder 150 can be seen.

FIG. 10 shows an installation connection device 100 mounted in a housing 50. Of the housing opening 52, only an edge can still be seen; the rest is concealed by the stop structure 130.

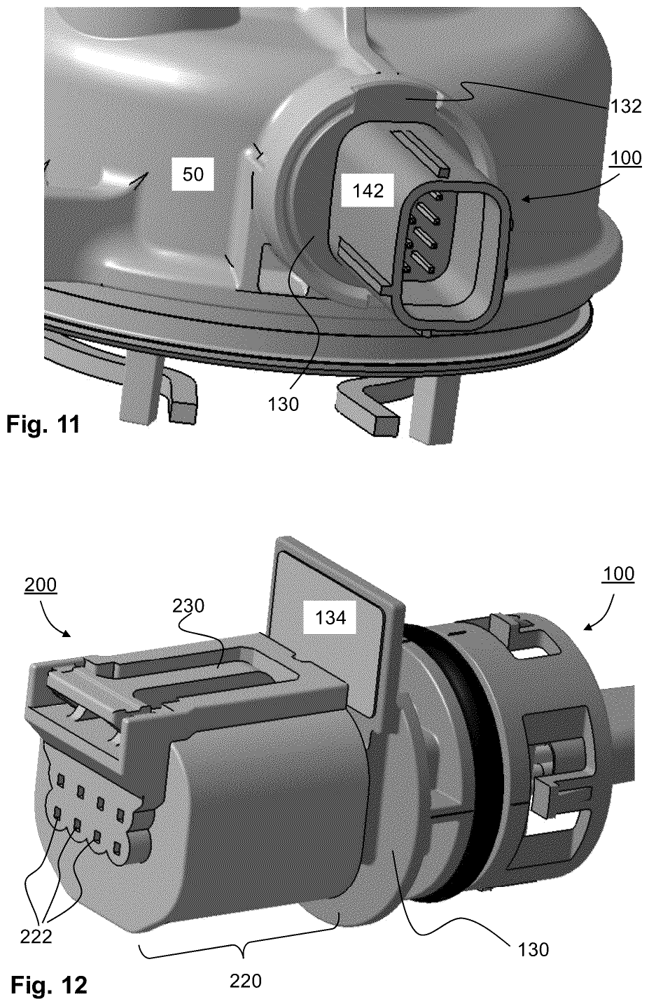

FIG. 11 shows another example of an installation connection device 100 mounted in a housing 50. In this example, it is clear how the positioning structure 132 corresponds with a hole at the housing opening of the housing 50 and fixes the position of the installation connection device 100.

FIG. 12 shows an exemplary embodiment of a part of a fit-on connection device 200 according to the invention fitted on an installation connection device 100 according to the invention. The figure shows merely the fit-on portion 220. The fit-on portion 220 has a form closed in a cup-like manner, the contour of which follows that of the collar 142 of the installation connection device 100 and surrounds said collar. Consequently, the collar 142 is not visible in the figure. In the fit-on portion 220, second line connection devices are arranged which correspond with corresponding first line connection devices 160 of the installation connection device 100 and contact said first line connection devices (not shown in the figure). The second line connection devices are arranged in or on the floor of the fit-on portion 220; the figure shows only the lead-throughs 222, which finally lead lines connected to the second line connection devices out of the fit-on portion 220. On the top side of the fit-on portion, a locking structure 230 can be seen, which here is formed by an elastic tongue that interacts with the locking projection 144 of the connection portion 140 of the installation connection device 100. For this purpose, an opening can be provided in the wall of the fit-on portion 220. Instead of an elastic tongue, an elastically supported rigid tongue can also be provided. In the fit-on portion 220, sealing means are provided, which cannot be seen in the figure and which interact with the collar of the installation connection device 100.

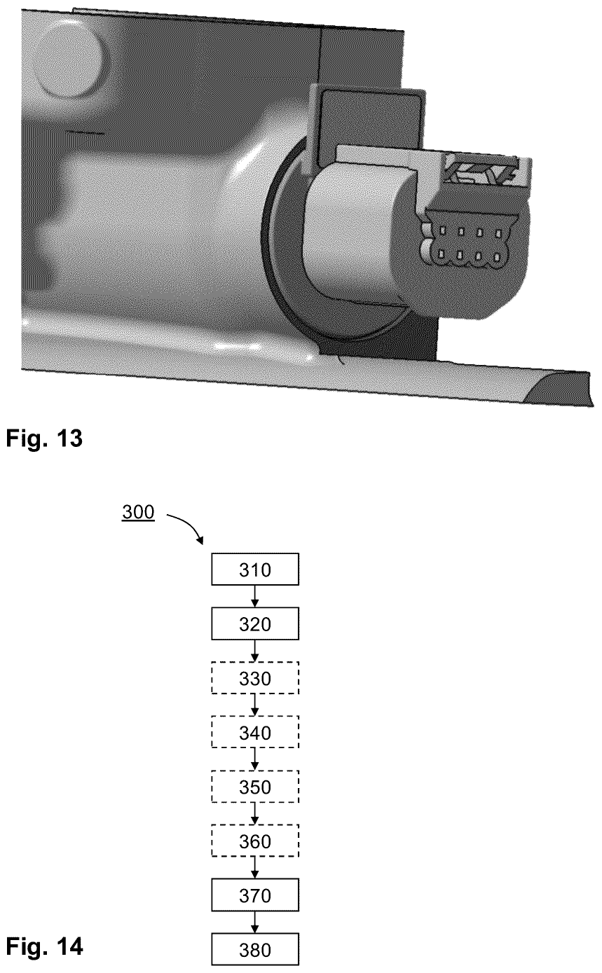

FIG. 13 shows an installation connection device 100 according to the invention mounted in a housing 50, with a fitted-on fit-on portion 220 of a fit-on connection device 200 according to the invention. Reference signs are not used in the figure; the individual elements have already been described in FIGS. 10 and 12.

FIG. 14 shows an exemplary flowchart of a method 300 for mounting an installation connection device 100 according to the invention in a housing opening 52. In step 310, a housing 50, which has a housing opening 52 and one or more lines 170 connected within the housing 50, and a body 102 of the installation connection device 100 are provided. In step 320, the one or more lines 170 are led through the housing opening 52 out of the interior of the housing. If the one or more lines 170 are not yet provided with first line connection devices 160, in step 330, first line connection devices 160 are provided, and in step 340 each of the one or more lines 170 is connected to a respective first line connection device 160. If the first line connection devices 160 connected to lines 170 are not yet supported and fixed in a holder 150, in step 350 a holder 150 is provided, and in step 360 the first line connection devices 160 connected to lines 170 are arranged in the holder 150. In step 370, the holder 150 is received in the body, and finally in step 380 the installation connection device 100 is inserted into and fixed in the housing opening 52. In the figure, the conditional steps are shown with dashed boxes.

### LIST OF REFERENCE SIGNS (PART OF THE DESCRIPTION)

10 Connection assembly
12 Line
14 Corrugated tube
16 Seal
18 Sleeve
20 Plugging connector
22 Connection housing
50 Housing
52 Housing opening
100 Installation connection device
102 Body
120 Installation portion
122 Sealing means
124 Fixing structure
130 Stop structure
132 Positioning structure
134 Plate
140 Connection portion
142 Collar
144 Locking structure
146 First guide structure
148 Through-hole
150 Holder
152 Protuberance
154 Locking element
156 Front plate
160 First line connection device
162 Crimp connection point
164 Locking element
166 Contact pin
170 Line
172 Line guide element
200 Fit-on connection device
220 Fit-on portion
222 Lead-throughs
230 Second locking structure
300 Method
310 Providing
320 Leading through
330 Providing
340 Connecting
350 Providing
360 Arranging
370 Receiving
380 Inserting and fixing

1. An installation connection device for installation in a housing opening, comprising:
a body, which has an installation portion of round cross section, and
a connection portion,
wherein the installation portion comprises a peripheral sealing means designed for sealing with respect to the housing opening or with respect to the housing wall containing the housing opening and is delimited at the transition to the connection portion by a stop structure,
wherein the installation portion also has one or more fixing structures designed to fix the installation portion in the housing opening or to the wall surrounding the housing opening,
wherein, on the side of the stop structure opposite from the installation portion, a collar having a peripherally closed wall is integrally formed on the stop structure,
wherein, in the body, a holder is removably supported and fixed without a seal, which holder is designed to releasably receive, without a seal, one or more first line connection devices, which each provide a connection point of a line connected thereto for a corresponding second line connection device provided in a fit-on connection device comprising a body, which has a fit-on portion and a connection portion, wherein the fit-on portion has a form closed in a cup-like manner, the contour of which follows the collar of the installation connection device and which is designed to surround the collar,
wherein, on or in the floor of the fit-on portion, one or more second line connection devices are arranged, which correspond with corresponding first line connection devices of the installation connection device and are designed to contact said first line connection devices, wherein, in the interior of the form closed in a cup-like manner, a sealing means is arranged on the floor of the fit-on portion or near the floor along the inside of the form closed in a cup-like manner, said sealing means being designed to interact with the collar of the installation connection device in the connected state and to seal, toward the floor of the form closed in a cup-like manner, the internal space formed by the collar of the installation connection device, wherein lines each connected to a second line connection device are led fluid-tight through the floor of the form closed in a cup-like manner and into the connection portion and the connection portion leads the lines out of the fit-on connection device without a seal, or wherein lines each connected to a second line connection device are led, without a seal, through the floor of the form closed in a cup-like manner and into the connection portion, and the connection portion leads the lines out of the fit-on connection device through a sealing means, or leads the lines into a line guide element which is connected to the connection portion fluid-tight by a sealing means,
said fit-on connection device being coupled to the connection portion,
wherein the holder is supported in the body such that the one or more first line connection devices are accessible within the space surrounded by the collar wall.

2. The installation connection device as claimed in claim 1, wherein the one or more first line connection devices comprise fluid couplings or electrically conductive contact pins, contact sleeves or spring clamps.

3. The installation connection device as claimed in claim 1, wherein one or more first guide structures for positioning and/or guiding a fit-on connection device are provided on the collar wall and/or wherein one or more first locking structures for locking a fit-on connection device which is coupled to the connection portion are provided on the collar wall.

4. The installation connection device as claimed in claim 1, wherein one or more positioning structures for positioning the installation connection device in a housing opening are provided on the stop structure.

5. The installation connection device as claimed in claim 1, wherein one or more second guide structures designed to interact with corresponding first guide structures of the installation connection device are provided in the wall of the form closed in a cup-like manner, and/or wherein one or more second locking structures designed to interact with the one or more first locking structures of the installation connection device are provided on or in the wall of the form closed in a cup-like manner.

6. The installation connection device as claimed in claim 1, wherein the one or more second line connection devices comprise fluid couplings or electrically conductive contact pins, contact sleeves or spring clamps.

7. A fluid-tight connection assembly comprising an installation connection device as claimed in claim 1.

8. A method for mounting an installation connection device as claimed in one of claim 1 in a housing opening, comprising:
providing a housing, which has a housing opening and one or more lines connected within the housing, and providing a body of the installation connection device,
leading the one or more lines through the housing opening out of the interior of the housing,
wherein, if the one or more lines are not yet provided with first line connection devices, the method also comprises:
providing first line connection devices,
connecting each of the one or more lines to a respective first line connection device, wherein, if the first line connection devices connected to lines are not yet supported and fixed in a holder, the method also comprises:
providing a holder, and
arranging the first line connection devices connected to lines in the holder, wherein the method also comprises:
receiving the holder in the body, and
inserting the installation connection device into and fixing it in the housing opening.

10. A fit-on connection device for connection to an installation connection device, a body, which has an installation portion of round cross section, and
a connection portion,
wherein the installation portion comprises a peripheral sealing means designed for sealing with respect to the housing opening or with respect to the housing wall containing the housing opening and is delimited at the transition to the connection portion by a stop structure,
wherein the installation portion also has one or more fixing structures designed to fix the installation portion in the housing opening or to the wall surrounding the housing opening,
wherein, on the side of the stop structure opposite from the installation portion, a collar having a peripherally closed wall is integrally formed on the stop structure,
wherein, in the body, a holder is removably supported and fixed without a seal, which holder is designed to releasably receive, without a seal, one or more first line connection devices, which each provide a connection point of a line connected thereto for a corresponding second line connection device provided in the fit-on connection device;
said fit on connection device comprising a body, which has a fit-on portion and a connection portion,
wherein the fit-on portion has a form closed in a cup-like manner, the contour of which follows the collar of the installation connection device and which is designed to surround the collar, wherein, on or in the floor of the fit-on portion, one or more second line connection devices are arranged, which correspond with corresponding first line connection devices of the installation connection device and are designed to contact said first line connection devices,
wherein, in the interior of the form closed in a cup-like manner, a sealing means is arranged on the floor of the fit-on portion or near the floor along the inside of the form closed in a cup-like manner, said sealing means being designed to interact with the collar of the installation connection device in the connected state and to seal, toward the floor of the form closed in a cup-like manner, the internal space formed by the collar of the installation connection device,
wherein lines each connected to a second line connection device are led fluid-tight through the floor of the form closed in a cup-like manner and into the connection portion and the connection portion leads the lines out of the fit-on connection device without a seal, or
wherein lines each connected to a second line connection device are led, without a seal, through the floor of the form closed in a cup-like manner and into the connection portion, and the connection portion leads the lines out of the fit-on connection device through a sealing means, or leads the lines into a line guide element which is connected to the connection portion fluid-tight by a sealing means.
